(19) United States
(12) Patent Application Publication
(10) Pub. No.: US 2023/0337077 A1
(43) Pub. Date: Oct. 19, 2023

(54) REQUEST SENDING METHOD, RESPONSE INFORMATION SENDING METHOD, AND POSITION INFORMATION ACQUISITION METHOD

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/027,857

(22) PCT Filed: Sep. 29, 2020
(86) PCT No.: PCT/CN2020/119015

§ 371 Date: Mar. 22, 2023

(51) Int. Cl. H04W 36/00

(52) U.S. Cl. CPC H04W 36/00835; H04W 36/0085

(57) ABSTRACT

The disclosure relates to a request sending method, including: sending a first acquisition request for acquiring position information of a terminal to a first base station corresponding to a cell where the terminal is currently located; and in response to determining, according to response information of the first acquisition request, a cell to which the terminal is to be handed over, sending a second acquisition request for acquiring position information of the terminal to at least one base station corresponding to at least one target cell to which the terminal is to be handed over.

### CROSS-REFERENCE TO RELATED APPLICATION

The present application is a U.S. National Stage of International Application No. PCT/CN2020/119015, filed on Sep. 29, 2020, the contents of all of which are incorporated herein by reference in their entireties for all purposes.

### BACKGROUND

When a location of a terminal needs to be determined, a core network may acquire a measurement result of a sounding reference signal (SRS) sent by a base station to the terminal, and then the location of the terminal is determined according to the measurement result.

### SUMMARY

According to a first aspect of an example of the disclosure, a request sending method is provided and applicable to a core network, and the method includes: sending a first acquisition request for acquiring position information of a terminal to a first base station corresponding to a cell where the terminal is currently located; and in response to determining, according to response information of the first acquisition request, a cell to which the terminal is to be handed over, sending a second acquisition request for acquiring position information of the terminal to at least one base station corresponding to at least one target cell to which the terminal is to be handed over.

According to a second aspect of an example of the disclosure, a response information sending method is provided and applicable to a first base station, and the method includes: receiving a first acquisition request for acquiring position information of a terminal sent by a core network; and sending, in response to determining a cell to which the terminal is to be handed over, response information of the first acquisition request to the core network, where, the response information is used to indicate at least one base station corresponding to at least one target cell to which the terminal is to be handed over to the core network.

According to a third aspect of an example of the disclosure, a position information acquisition method is provided and applicable to a second base station, and the method includes: receiving a second acquisition request for acquiring position information of a terminal sent by a core network; acquiring, in response to that the terminal is handed over from a cell corresponding to a first base station to a cell corresponding to the second base station, a measurement result according to a request information sent by the core network, the measurement result is obtained by measuring an SRS sent by the terminal; and sending the measurement result to the core network.

According to a fourth aspect of an example of the disclosure, an electronic device is provided, including: a processor; and a memory, configured to store processor executable instructions. The processor is configured to implement the above request sending method, and/or the above response information sending method, and/or the above position information acquisition method.

According to a fifth aspect of an example of the disclosure, a computer readable storage medium is provided, storing a computer program, where the program, when executed by a processor, implements steps in the above request sending method, and/or the above response information sending method, and/or the above position information acquisition method.

### BRIEF DESCRIPTION OF THE DRAWINGS

In order to more clearly explain technical solutions in examples of the disclosure, accompanying drawings needed to be used in description of the examples will be briefly introduced below. Apparently, the accompanying drawings in the following description are merely some examples of the disclosure. For those of ordinary skill in the art, other accompanying drawings may further be obtained according to these accompanying drawings without paying creative labor.

FIG. 1 is a schematic flow chart of a request sending method illustrated according to an example of the disclosure.

FIG. 2 is a schematic flow chart of another request sending method illustrated according to an example of the disclosure.

FIG. 3 is a schematic flow chart of yet another request sending method illustrated according to an example of the disclosure.

FIG. 4 is a schematic flow chart of yet another request sending method illustrated according to an example of the disclosure.

FIG. 5 is a schematic flow chart of yet another request sending method illustrated according to an example of the disclosure.

FIG. 6 is a schematic flow chart of yet another request sending method illustrated according to an example of the disclosure.

FIG. 7 is a schematic flow chart of yet another request sending method illustrated according to an example of the disclosure.

FIG. 8 is a schematic flow chart of yet another request sending method illustrated according to an example of the disclosure.

FIG. 9 is a schematic flow chart of a response information sending method illustrated according to an example of the disclosure.

FIG. 10 is a schematic flow chart of another response information sending method illustrated according to an example of the disclosure.

FIG. 11 is a schematic flow chart of a position information acquisition method illustrated according to an example of the disclosure.

FIG. 12 is a schematic flow chart of yet another position information acquisition method illustrated according to an example of the disclosure.

FIG. 13 is a schematic flow chart of yet another position information acquisition method illustrated according to an example of the disclosure.

FIG. 14 is a schematic flow chart of yet another position information acquisition method illustrated according to an example of the disclosure.

FIG. 15 is a schematic diagram of interaction of a terminal, a first base station, a second base station and a core network illustrated according to an example of the disclosure.

FIG. 16 is a schematic block diagram of a request sending apparatus illustrated according to an example of the disclosure.

FIG. 17 is a schematic block diagram of another request sending apparatus illustrated according to an example of the disclosure.

FIG. 18 is a schematic block diagram of yet another request sending apparatus illustrated according to an example of the disclosure.

FIG. 19 is a schematic block diagram of yet another request sending apparatus illustrated according to an example of the disclosure.

FIG. 20 is a schematic block diagram of yet another request sending apparatus illustrated according to an example of the disclosure.

FIG. 21 is a schematic block diagram of yet another request sending apparatus illustrated according to an example of the disclosure.

FIG. 22 is a schematic block diagram of a response information sending apparatus illustrated according to an example of the disclosure.

FIG. 23 is a schematic block diagram of another response information sending apparatus illustrated according to an example of the disclosure.

FIG. 24 is a schematic block diagram of a position information acquisition apparatus illustrated according to an example of the disclosure.

FIG. 25 is a schematic block diagram of another position information acquisition apparatus illustrated according to an example of the disclosure.

FIG. 26 is a schematic block diagram of another position information acquisition apparatus illustrated according to an example of the disclosure.

FIG. 27 is a schematic block diagram of yet another position information acquisition apparatus illustrated according to an example of the disclosure.

FIG. 28 is a schematic block diagram of an apparatus for sending response information and/or acquiring above position information illustrated according to an example of the disclosure.

FIG. 29 is a schematic block diagram of a terminal illustrated according to an example of the disclosure.

### DETAILED DESCRIPTION

The disclosure relates to the technical field of communication, in particular to a request sending method, a response information sending method, a position information acquisition method, a request sending apparatus, a response information sending apparatus, a position information acquisition apparatus, an electronic device and a computer readable storage medium.

When a location of a terminal needs to be determined, a core network may acquire a measurement result of a sounding reference signal (SRS) sent by a base station to the terminal, and then the location of the terminal is determined according to the measurement result. However, based on a current method, a position service may be interrupted.

For instance, when cell handover of the terminal is performed, the terminal may hand over from one cell to another cell, and then may send the SRS to a base station corresponding to the cell handed over. However, the core network may not be able to determine the cell handed over of the terminal, resulting in the core network being unable to timely acquire the measurement result of the SRS sent by the base station corresponding to the cell handed over of the terminal to the terminal, thus interrupting a position process of the terminal.

In view of this, examples of the disclosure provide a request sending method, a response information sending method, a position information acquisition method, a request sending apparatus, a response information sending apparatus, a position information acquisition apparatus, an electronic device and a computer readable storage medium, so as to solve technical problems in the related art.

The technical solutions in the examples of the disclosure will be clearly and completely described below with reference to the accompanying drawings in the examples of the disclosure. The described examples are merely a part of the examples of the disclosure, not all of the examples. Based on the examples of the disclosure, all other examples obtained by those of ordinary skill in the art without creative labor fall within the scope of protection of the disclosure.

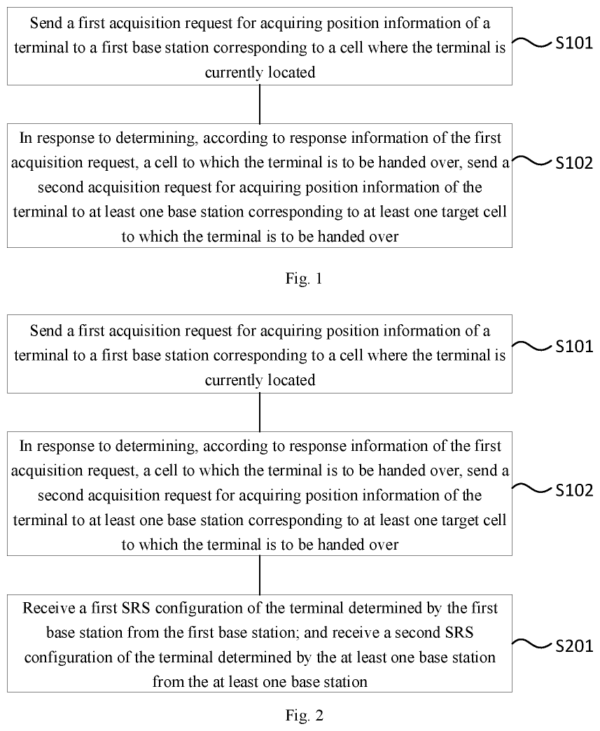

FIG. 1 is a schematic flow chart of a request sending method illustrated according to an example of the disclosure. The method shown in this example may be applied to a core network, the core network includes, but is not limited to, a location management function (LMF), an access and mobility management function (AMF) and other functions, and the method in one example may be specifically applied to the LMF.

The core network includes, but is not limited to, a 5G core network and a 6G core network. The core network may communicate with a base station, for instance, an acquisition request of position information is sent to the base station, after receiving the acquisition request, the base station may determine a sounding reference signal (SRS) configuration of a terminal and send the SRS configuration to the core network, and may further send the SRS configuration to the terminal, so as to indicate the terminal to send SRS resources.

The SRS is a reference signal sent by the terminal to the base station, which may be used for uplink positioning of the terminal, and may be called a positioning SRS or a UL positioning SRS.

The core network may send the received SRS configuration to one or more base stations. The one or more base stations may receive the SRS sent by the terminal based on the SRS configuration and measure the SRS configuration sent by the terminal, and then send measurement results to the core network. The core network may determine a location of the terminal based on a plurality of (such as two or more than two) measurement results. The terminal includes, but not limited to, a mobile phone, a tablet, a wearable device, an industrial sensor, an Internet of Things device and other electronic devices.

As shown in FIG. 1, the request sending method may include the following steps S101 and S102.

In step S101, a first acquisition request for acquiring position information of a terminal is sent to a first base station corresponding to a cell where the terminal is currently located.

In step S102, in response to determining, according to response information of the first acquisition request, a cell to which the terminal is to be handed over, a second acquisition request for acquiring position information of the terminal is sent to at least one base station corresponding to at least one target cell to which the terminal is to be handed over.

In one example, when the location of the terminal needs to be determined, the core network may determine the first base station corresponding to the cell where the terminal is currently located (such as a service cell) firstly, and then send the first acquisition request to the first base station, so as to acquire a first SRS configuration of the terminal determined by the first base station.

In one example, the core network may carry the first acquisition request through an NR positioning protocol A (NRPPa) message and send it to the first base station, and the first acquisition request may be, for instance, a positioning information request message in the NRPPa message.

Similarly, the core network may carry a second acquisition request through the NRPPa message and send it to the at least one base station, and the second acquisition request may be, for instance, a positioning information request message in the NRPPa message.

After receiving the first acquisition request, the first base station may send response information (positioning information response) of the first acquisition request to the core network, and may determine whether cell handover of the terminal is to be performed.

For instance, the terminal may measure information of a neighbor base station of the first base station, including, but is not limited to, related information of signals, such as reference signal receiving power (RSRP) and reference signal receiving quality (RSRQ), and then send the measured information to the first base station. The first base station may determine whether cell handover of the terminal is to be performed according to the measured information.

For instance, the base station may perform mobility state estimation (MSE) on the terminal, and then determine whether the terminal is to leave the current cell according to a mobility state estimation result, so as to generate an action of cell handover.

It needs to be noted that there may be a plurality of cells that meet handover conditions, so the first base station determines that the cell to which the terminal is to be handed over may also be multiple, and the plurality of cells may correspond to one base station or a plurality of base stations.

In a case that cell handover of the terminal is determined to be performed, the first base station may add indication information in the response information to indicate to the core network that cell handover of the terminal is to be performed and at least one base station corresponding to at least one target cell to which the terminal may be handed over, so that the core network determines that cell handover of the terminal is to be performed, and the at least one base station corresponding to the at least one target cell to which the terminal is to be handed over.

Accordingly, the core network may send the second acquisition request for acquiring the position information of the terminal to the at least one base station corresponding to the at least one target cell to which the terminal is to be handed over, so as to enable the at least one base station to know that the core network needs to position the terminal. In this way, after the terminal completes cell handover, the base station corresponding to the cell handed over may send the SRS configuration to the terminal immediately, receive an SRS sent from the terminal, measure the SRS sent by the terminal to obtain the measurement result, and then send the measurement result to the core network to ensure that the core network may obtain the measurement result in time, and then timely determine a location of the terminal on the basis of the measurement result.

FIG. 2 is a schematic flow chart of another request sending method illustrated according to an example of the disclosure. As shown in FIG. 2, the method includes steps S101 and S102 and further includes S201.

In step S201, a first SRS configuration of a terminal determined by a first base station is received from the first base station, and a second SRS configuration of the terminal determined by at least one base station is received from the at least one base station.

In one example, after receiving a first acquisition request, the first base station may determine an SRS resource of the terminal, determine the first SRS configuration according to the resource, and then send the first SRS configuration to the core network. For instance, the first base station may send the first SRS configuration to the core network by carrying it in the response information of the first acquisition request.

In one example, after receiving a second acquisition request, the at least one base station may determine SRS resources of the terminal respectively, determine a second SRS configuration according to the resources, and then send the second SRS configuration to the core network. For instance, the at least one base station may send the second SRS configuration to the core network by carrying it in the response information of the second acquisition request. For instance, the at least one base station includes a gNB2 and a gNB3. In this way, the gNB2 may determine the second SRS configuration of the terminal and send it to the core network, the gNB3 may determine the second SRS configuration of the terminal and send it to the core network, and the second SRS configuration determined by the gNB2 may be different from the second SRS configuration determined by the gNB3.

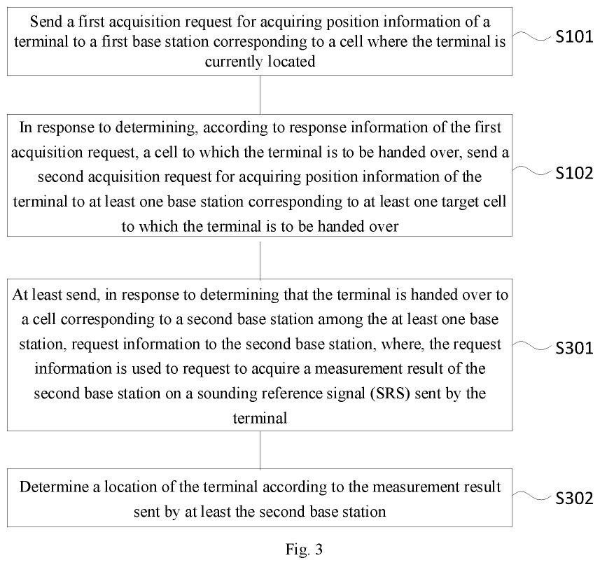

FIG. 3 is a schematic flow chart of yet another request sending method illustrated according to an example of the disclosure. As shown in FIG. 3, the method includes steps S101 and S102 and further includes S301 and S302.

In step S301, in response to determining that the terminal has been handed over to a cell corresponding to a second base station among the at least one base station, request information is at least sent to the second base station, where, the request information is used to request to acquire a measurement result of the second base station on a sounding reference signal (SRS) sent by the terminal.

In step S302, a location of the terminal is determined according to the measurement result sent by at least the second base station.

In one example, the core network may determine that the terminal is handed over from a cell corresponding to the first base station to a cell corresponding to the second base station through an AMF, so that the request information is at least sent to the second base station, so as to request to acquire the measurement result of the SRS sent by the second base station to the terminal, and then the location of the terminal is determined based on the measurement result at least from the second base station.

In one example, the measurement result includes, but not limited to, received time, angle, signal strength and other information of the SRS. In addition, the core network may determine the location of the terminal according to the measurement result, and may further acquire the second SRS configuration of the terminal determined by the second base station, the second SRS configuration may indicate the terminal to send the SRS resources to the second base station, and the core network may determine the location of the terminal according to configuration information and the measurement result. The above two methods for determining the location may be selected specifically according to the needs of a position algorithm.

It needs to be noted that the core network may send the request information merely to the second base station, and may further send the request information to a neighbor base station of the second base station, which may be selected specifically according to the needs. Two examples are used as instances for illustration below.

In some embodiments, the request information carries an identifier of the terminal. In one example, the request information sent to the second base station may carry the identifier of the terminal, so that the second base station determines the terminal according to the identifier, so as to measure an SRS configured for the terminal and an SRS sent to the terminal.

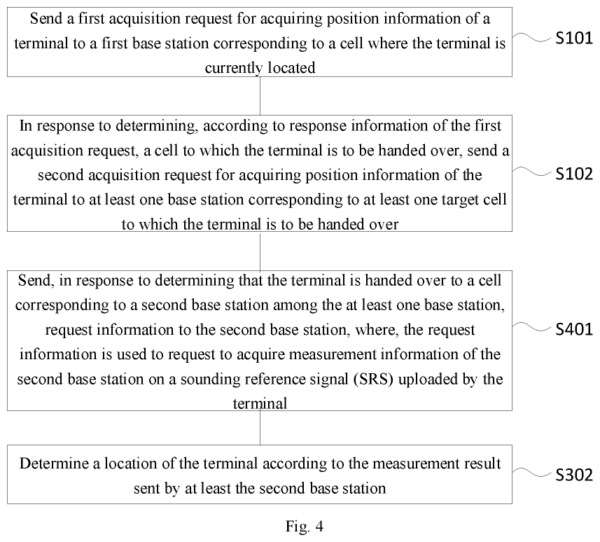

FIG. 4 is a schematic flow chart of yet another request sending method illustrated according to an example of the disclosure. As shown in FIG. 4, the method includes steps S101, S102, and S302 and at least sending the request information to the second base station includes step S401.

in step S401, the request information is sent to the second base station.

In one example, the core network may send the request information merely to the second base station. For instance, a plurality of (two or more than two) TRPs (transmission reception points) are set on the second base station, each TRP may receive the SRS sent by the terminal and measure the SRS sent by the terminal, so that one measurement result may be obtained based on each TRP. Each TRP receives the SRS sent by the terminal according to the same configuration information, and the measurement results obtained by different TRPs may be different.

In this way, in a case that the plurality of TRPs are set on the second base station, the second base station may obtain a plurality of measurement results. Based on the request information, the second base station may send the measurement results obtained by the plurality of TRPs respectively to the core network, so that the core network determines the location of the terminal according to the plurality of received measurement results.

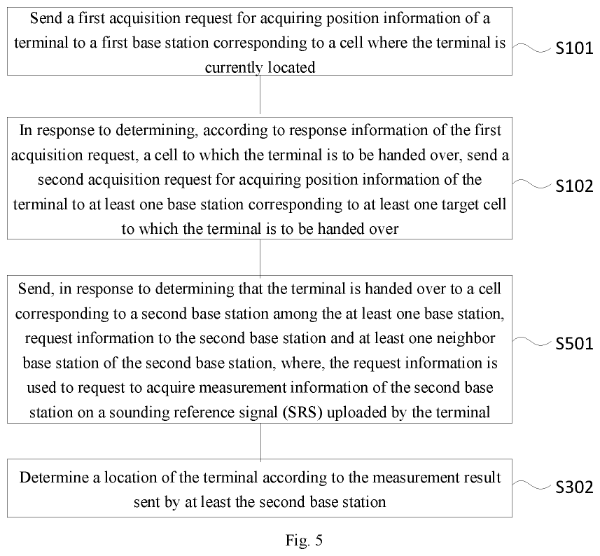

FIG. 5 is a schematic flow chart of yet another request sending method illustrated according to an example of the disclosure. As shown in FIG. 5, the method includes steps S101, S102, and S302 and at least sending the request information to the second base station includes step S501.

In step S501, the request information is sent to the second base station and at least one neighbor base station of the second base station.

In one example, after receiving the second acquisition request, the at least one base station may determine SRS resources of the base station corresponding to the terminal respectively, determine the second SRS configuration according to the resources, and then send the second SRS configuration to the core network. For instance, the at least one base station may send the second SRS configuration to the core network by carrying it in the response information of the second acquisition request. For instance, the at least one base station includes a gNB2 and a gNB3. In this way, the gNB2 may determine the second SRS configuration of the gNB2 corresponding to the terminal and send it to the core network, the gNB3 may determine the second SRS configuration of the gNB3 corresponding to the terminal and send it to the core network, and the second SRS configuration determined by the gNB2 may be different from the second SRS configuration determined by the gNB3.

The core network may send the request information to the second base station and at least one neighbor base station of the second base station, and request to acquire the measurement results sent by the second base station and the neighbor base station to the terminal through the request information. The terminal may send the SRS to the second base station and the neighbor base station, so that the second base station may measure the SRS sent by the terminal to obtain a measurement result. The neighbor base station of the second base station may also measure the SRS sent by the terminal to obtain a measurement result, so that the second base station and the neighbor base station of the second base station may send the obtained measurement results to the core network. Thus, enabling the core network to determine the location of the terminal according to the plurality of received measurement results.

In some embodiments, the request information carries a second SRS configuration of the terminal determined by the second base station. In one example, the second base station may determine the second SRS configuration, which is used to indicate the terminal to send SRS resources (including a time domain resource and a frequency domain resource) to the second base station, and the second base station may send the second SRS configuration to the core network.

The core network may carry the second SRS configuration in the sent request information, then the neighbor base station that receives the request information may acquire the second SRS configuration from the request information, so that the SRS sent by the terminal may be received according to the second SRS configuration, and the SRS sent by the terminal is measured.

By sending the second SRS configuration to the second base station, the second base station that receives the second SRS configuration may receive the SRS sent by the terminal based on the second SRS configuration. Hence, there is no need to send the identifier of the terminal to the second base station, so that the second base station may determine to receive the SRS sent by the terminal.

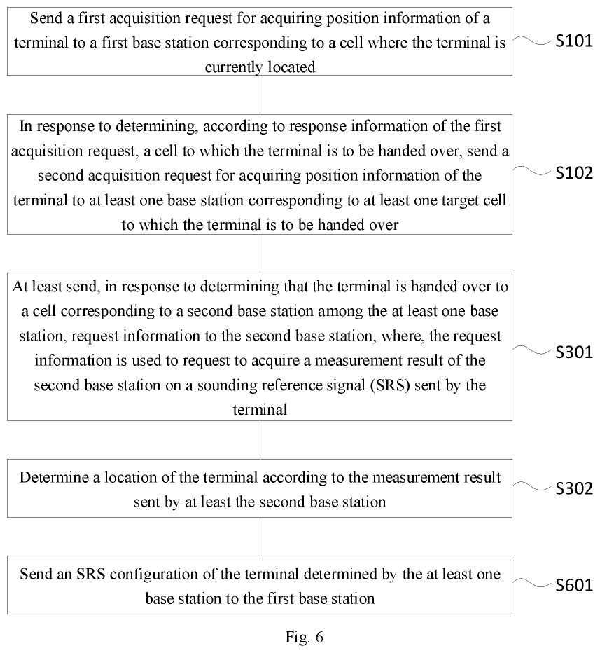

FIG. 6 is a schematic flow chart of yet another request sending method illustrated according to an example of the disclosure. As shown in FIG. 6, the method includes steps S101, S102, S301 and S302 and further includes step S601.

In step S601, an SRS configuration of a terminal determined by at least one base station is sent to a first base station.

In one example, after receiving a second acquisition request, the at least one base station may determine SRS resources of the base station corresponding to the terminal respectively, determine a second SRS configuration according to the resources, and then send the second SRS configuration to a core network. For instance, the at least one base station may send the second SRS configuration to the core network by carrying it in response information of the second acquisition request.

For instance, the at least one base station includes a gNB2 and a gNB3. In this way, the gNB2 may determine the second SRS configuration of the gNB2 corresponding to the terminal and send it to the core network, the gNB3 may determine the second SRS configuration of the gNB3 corresponding to the terminal and send it to the core network, and the second SRS configuration determined by the gNB2 may be different from the second SRS configuration determined by the gNB3.

For instance, for a second base station, the second base station may determine the second SRS configuration of the terminal and indicate the terminal to send the SRS resources through the second SRS configuration. As a base station among the at least one base station, the second base station may send the second SRS configuration to the core network, and this action may be performed before the terminal completes cell handover or in a cell handover process of the terminal.

Then the core network may send the second SRS configuration to a first base station, and the first base station may send the second SRS configuration to the terminal, so that before the terminal is handed over to the second base station. The SRS resources sent by the corresponding second base station may be determined according to the second SRS configuration. The second base station may not need to send the second SRS configuration to the terminal again, so that the terminal sends the SRS as soon as possible, the second base station completes the measurement as soon as possible, and thus positioning delay is reduced.

In some embodiments, the second acquisition request further includes a first SRS configuration of the terminal determined by the first base station.

In one example, the first base station determines the first SRS configuration of the terminal and indicates the terminal to send the SRS resources to the first base station through the first SRS configuration, and the first base station may further send the first SRS configuration to the core network. This action may be performed before the terminal completes cell handover or in the cell handover process of the terminal.

Then the core network may send the first SRS configuration to the second base station. For instance, the core network sends the first SRS configuration by carrying it in the second acquisition request to the second base station, so that the second base station may also receive the SRS sent by the terminal according to the first SRS configuration and measure it. Thus, there is no need to send the configuration information to the terminal again, which is conducive to reducing the load of the second base station. Based on this, the second base station receives the SRS sent by the terminal as soon as possible.

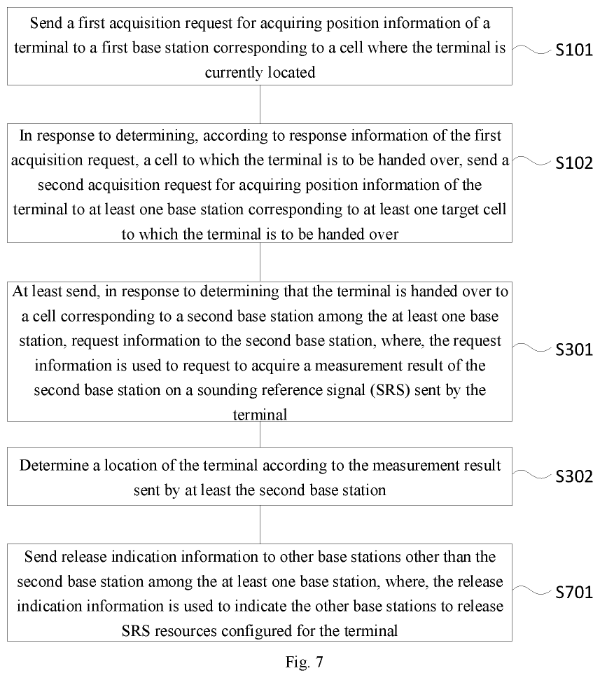

FIG. 7 is a schematic flow chart of yet another request sending method illustrated according to an example of the disclosure. As shown in FIG. 7, the method includes steps S101, S102, S301 and S302 and further includes step S701.

In step S701, release indication information is sent to other base stations other than a second base station among at least one base station, where, the release indication information is used to indicate the other base stations to release SRS resources configured for a terminal.

In one example, before the terminal is not handed over to the second base station, the core network can merely determine that the terminal is to hand over to the at least one base station, so it will send the second acquisition request to the at least one base station. After receiving the second acquisition request, each base station among the at least one base station may configure the SRS resources for the terminal.

However, the terminal finally may merely be handed over to a cell corresponding to a certain base station among the at least one base station, that is, a cell corresponding to the second base station, and then, the terminal will not use the SRS resources configured for the terminal by other base stations other than the second base station among the at least one base station. Accordingly, the core network may send the release indication information to the other base stations, so as to indicate the other base stations to release the SRS resources configured for the terminal. Thus, unnecessary occupation of communication resources is reduced.

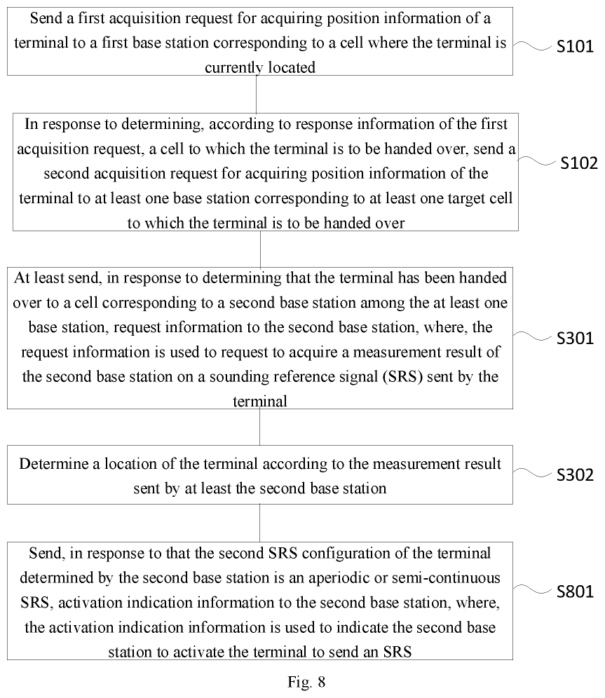

FIG. 8 is a schematic flow chart of yet another request sending method illustrated according to an example of the disclosure. As shown in FIG. 8, the method includes steps S101, S102, S301 and S302 and further includes step S801.

In step S801, in response to that a second SRS configuration of a terminal determined by a second base station is an aperiodic or semi-continuous SRS, activation indication information is sent to the second base station, where, the activation indication information is used to indicate the second base station to activate the terminal to send the SRS.

In one example, the method that the terminal sends the SRS based on the second SRS configuration includes, but is not limited to, periodic sending, aperiodic sending or semi-continuous sending. In the case of periodic sending, the terminal may send the SRS periodically, while in the case of aperiodic and semi-continuous sending of the SRS, the terminal needs the activation of the base station to send the SRS.

Hence, in the case that the terminal sends the SRS in an aperiodic or semi-continuous mode, the core network may send the activation indication information to the second base station, so that the second base station activates the terminal to send the SRS, so as to obtain a measurement result to send to the core network.

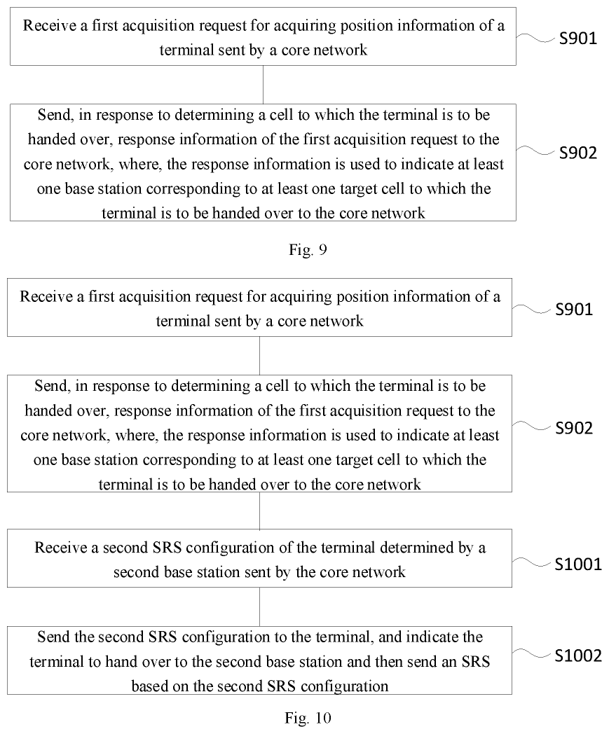

FIG. 9 is a schematic flow chart of a response information sending method illustrated according to an example of the disclosure. The method shown in this example may be applied to a first base station, for instance, the first base station in the above request sending method. The first base station includes, but is not limited to, a 5G base station and a 6G base station. The first base station may communicate with a terminal and a core network, and the terminal includes, but is not limited to, a mobile phone, a tablet, a wearable device, an industrial sensor, an Internet of Things device and other electronic devices.

As shown in FIG. 9, the response information sending method may include the following steps S901 and S902.

In step S901, a first acquisition request for acquiring position information of the terminal sent by the core network is received.

In step S902, in response to determining a cell to which the terminal is to be handed over, response information of the first acquisition request is sent to the core network, where, the response information is used to indicate at least one base station corresponding to at least one target cell to which the terminal is to be handed over to the core network.

In one example, when a location of the terminal needs to be determined, the core network may determine the first base station corresponding to the cell where the terminal is currently located (such as a service cell) firstly, and then send the first acquisition request to the first base station, so as to acquire a first SRS configuration of the terminal determined by the first base station.

In one example, the core network may carry the first acquisition request through an NRPPa message and send it to the first base station, and the first acquisition request may be, for instance, a positioning information request message in the NRPPa message.

After receiving the first acquisition request, the first base station may send response information of the first acquisition request to the core network, the response information may include the first SRS configuration in the above example, and it may determine whether cell handover of the terminal is to be performed.

For instance, the terminal may detect information of a neighbor base station of the first base station, including, but is not limited to, signal-related information, such as RSRP and RSRQ, and then send the detected information to the first base station. The first base station may determine whether cell handover of the terminal is to be performed according to the detected information.

For instance, the base station may perform mobility state estimation on the terminal, and then determine whether the terminal is to leave the current cell according to a mobility state estimation result, so as to generate an action of cell handover.

In a case that cell handover of the terminal is determined to be performed, the first base station may add indication information in the response information to indicate to the core network that cell handover of the terminal is to be performed and at least one base station corresponding to at least one target cell to which the terminal may be handed over.

Accordingly, the core network may determine that cell handover of the terminal is to be performed, and the at least one base station corresponding to the at least one target cell to which the terminal is to be handed over. Then the core network may send the second acquisition request for acquiring the position information of the terminal to the at least one base station corresponding to the at least one target cell to which the terminal is to be handed over, so as to enable the at least one base station to know that the core network needs to position the terminal. In this way, after the terminal completes cell handover, the base station corresponding to the cell handed over may receive an SRS sent from the terminal, measure the SRS sent by the terminal to obtain the measurement result, and then send the measurement result to the core network to ensure that the core network may obtain the measurement result in time, and then timely determine the location of the terminal on the basis of the measurement result.

FIG. 10 is a schematic flow chart of another response information sending method illustrated according to an example of the disclosure. As shown in FIG. 10, the method includes steps S901 and S902 and further includes steps S1001 and S1002.

In step S1001, a second SRS configuration of a terminal determined by a second base station sent by a core network is received.

The second base station is a base station among the at least one base station to which the terminal is handed over.

In step S1002, the second SRS configuration is sent to the terminal, and the terminal is indicated to hand over to the second base station and then send an SRS based on the second SRS configuration.

In one example, in a case that the terminal is handed over to a cell corresponding to the second base station, the second base station may send the second SRS configuration to the terminal and indicate the terminal to send SRS resources through the second SRS configuration, and the second base station may further send the second SRS configuration to the core network. This action may be performed before the terminal completes cell handover or in the cell handover process of the terminal.

Then the core network may send the second SRS configuration to the first base station, and the first base station may send the second SRS configuration to the terminal, so that after the terminal is handed over to the second base station, and the SRS may be sent according to the second SRS configuration. The second base station may not need to send the second SRS configuration to the terminal again. Based on this, the terminal sends the SRS as soon as possible and the second base station completes the measurement as soon as possible.

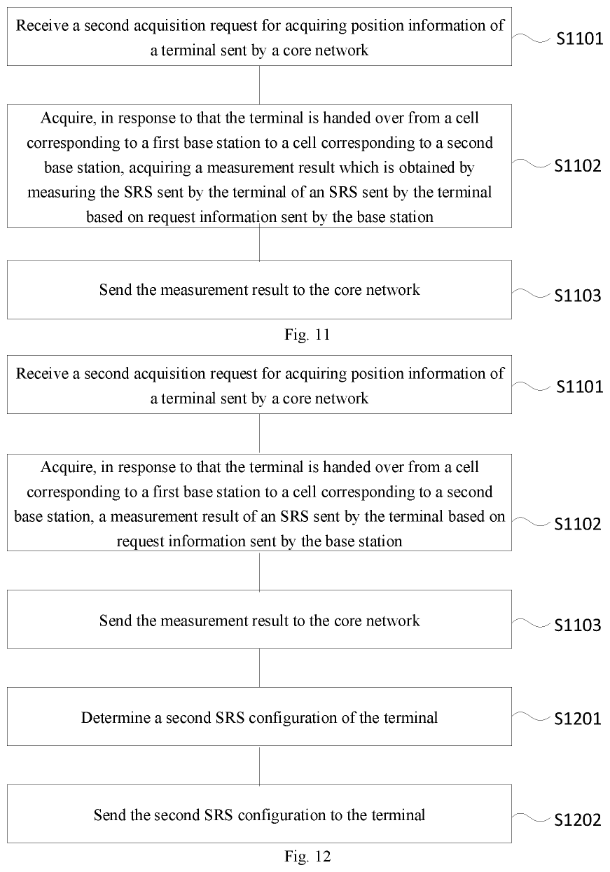

FIG. 11 is a schematic flow chart of a position information acquisition method illustrated according to an example of the disclosure. The method shown in this example may be applied to a second base station, for instance, the second base station in the above request sending method. The second base station includes, but not limited to, a 5G base station and a 6G base station. The second base station may communicate with the terminal and the core network, and the terminal includes, but not limited to, a mobile phone, a tablet, a wearable device, an industrial sensor, an Internet of Things device and other electronic devices.

As shown in FIG. 11, the response information sending method may include the following steps, S1101, S1102, and S1103.

In step S1101, a second acquisition request for acquiring position information of a terminal sent by a core network is received.

In step S1102, in response to that the terminal is handed over from a cell corresponding to a first base station to a cell corresponding to the second base station, acquiring a measurement result according to a request information sent by the core network, the measurement result is obtained by measuring an SRS sent by the terminal.

In step S1103, the measurement result is sent to the core network.

In one example, the first base station corresponding to the cell where the terminal is currently located may determine at least one base station corresponding to at least one cell to which the terminal is to be handed over when cell handover is to be performed, and then indicate the core network that cell handover of the terminal is to be performed. The at least one base station corresponding to the at least one cell to which the terminal is to be handed over, and the second base station may be a base station among the at least one base station.

The core network may send the second acquisition request to the at least one base station, thus enabling the at least one base station to know that the core network needs to position the terminal. In this way, after the terminal completes cell handover, the core network may send the request information to the second base station corresponding to the cell to which the terminal is handed over, so that the second base station receives an SRS sent from the terminal. The SRS sent by the terminal is measured to obtain the measurement result, and then the measurement result is sent to the core network to ensure that the core network may obtain the measurement result in time, and then timely determine the location of the terminal on the basis of the measurement result.

FIG. 12 is a schematic flow chart of yet another position information acquisition method illustrated according to an example of the disclosure. As shown in FIG. 12, the method includes steps S1101, S1102, and S1103 and further includes steps S1201 and S1202.

In step S1201, a second SRS configuration of a terminal is determined.

In step S1202, the second SRS configuration is sent to the terminal.

In one example, a second base station may determine the second SRS configuration of the terminal independently, and then send the second SRS configuration to the terminal, so as to indicate the terminal to send SRS resources.

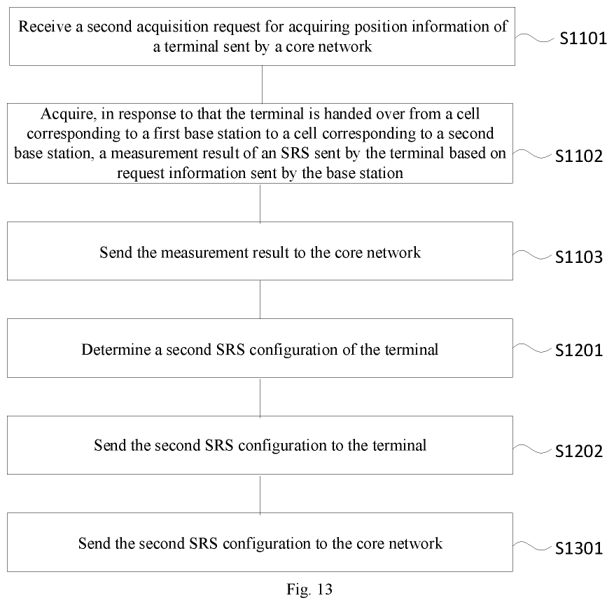

FIG. 13 is a schematic flow chart of yet another position information acquisition method illustrated according to an example of the disclosure. As shown in FIG. 13, the method includes steps S1101, S1102, S1103, S1201, and S1202 and further includes steps S1301.

In step S1301, a second SRS configuration is sent to a core network.

In one example, a second base station may send the second SRS configuration to a terminal and indicate the terminal to send SRS resources through the second SRS configuration, and the second base station may further send the second SRS configuration to the core network. This action may be performed before the terminal completes cell handover or in the cell handover process of the terminal.

Then the core network may send the second SRS configuration to a first base station, and the first base station may send the second SRS configuration to the terminal, so that after the terminal is handed over to the second base station, the SRS resources may be determined to be sent according to the second SRS configuration. The second base station may not need to send the second SRS configuration to the terminal again, so that the terminal sends the SRS as soon as possible, and the second base station completes the measurement as soon as possible.

In some embodiments, the method further includes: the second SRS configuration is received from the core network; and an SRS sent by the terminal is received according to the second SRS configuration.

In one example, the core network may send the second SRS configuration to the second base station, so that the second base station that receives the second SRS configuration may receive the SRS sent by the terminal based on the second SRS configuration. Accordingly, there is no need to send an identifier of the terminal to the second base station for the second base station to determine the terminal, so that the second base station may determine to receive the SRS sent by the terminal.

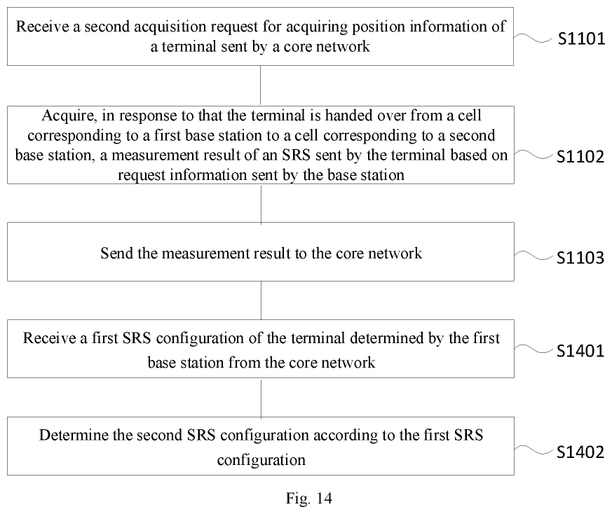

FIG. 14 is a schematic flow chart of yet another position information acquisition method illustrated according to an example of the disclosure. As shown in FIG. 14, the method includes steps S1101, S1102, and S1103 and further includes steps S1401, and S1402.

In step S1401, a first SRS configuration of a terminal determined by a first base station is received from the core network.

In step S1402, a second SRS configuration is determined according to the first SRS configuration.

In one example, the first base station may send the first SRS configuration to the terminal and indicate the terminal to send SRS resources through the first SRS configuration, and the first base station may further send the first SRS configuration to the core network. This action may be performed before the terminal completes cell handover or in the cell handover process of the terminal.

Then the core network may send the first SRS configuration to the second base station, so that the second base station may also determine the second SRS configuration according to the first SRS configuration. For instance, the first SRS configuration is taken as the second SRS configuration, so that the SRS sent by the terminal is received based on the first SRS configuration and measured. There is no need to send configuration information to the terminal again, which is conducive to reducing the load of the second base station. Therefore, the second base station receives the SRS sent by the terminal as soon as possible.

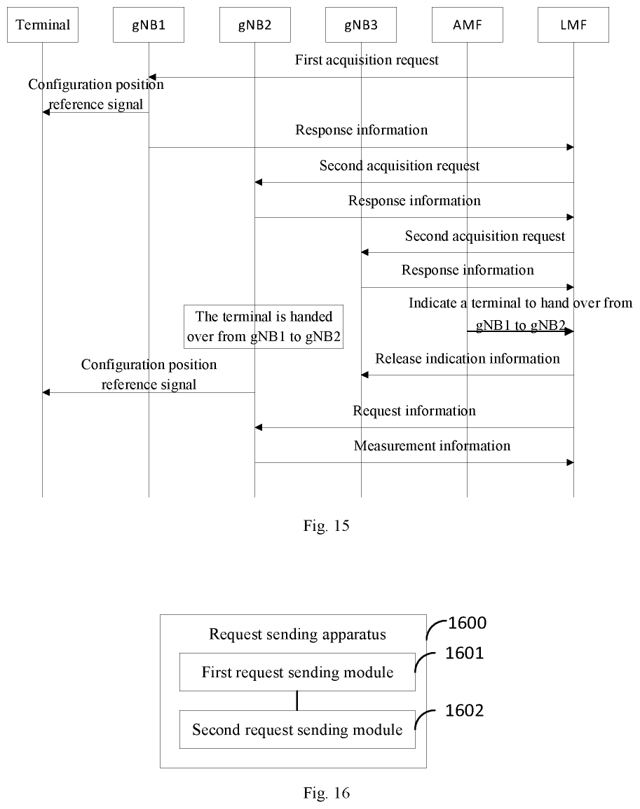

FIG. 15 is a schematic diagram of interaction of a terminal, a first base station, a second base station and a core network illustrated according to an example of the disclosure.

As shown in FIG. 15, when a location of the terminal needs to be determined, the core network may determine a base station corresponding to a cell where the terminal is currently located firstly, such as a gNB1 shown in FIG. 15, and the core network may send a first acquisition request to the gNB1 through an LMF. The first acquisition request may be carried in an NRPPa message, and specifically may be a positioning information request message in the NRPPa message.

The gNB1 may configure a position reference signal for the terminal, and send response information of the first acquisition request to the core network, and may further determine whether cell handover of the terminal is to be performed. In a case that cell handover of the terminal is determined to be performed, the first base station may add indication information in the response information to indicate to the core network that cell handover of the terminal is to be performed and at least one base station corresponding to at least one target cell to which the terminal may be handed over. For instance, at least one base station includes two base stations: gNB2 and gNB3.

After determining that the terminal is to be handed over to the gNB2 and the gNB3, the core network may send a second acquisition request to the gNB2 and the gNB3. The second acquisition request is carried in an NRPPa message, and specifically may be a positioning information request message in the NRPPa message.

After receiving the second acquisition request, the gNB2 may determine an SRS configuration 2, then send the SRS configuration 2 to the core network, and may further send information other than the SRS configuration 2 to the core network based on the positioning information request message, which is specifically determined based on contents requested by the positioning information request message.

Similarly, after receiving the second acquisition request, the gNB3 may determine an SRS configuration 3, then send the SRS configuration 3 to the core network, and may further send information other than the SRS configuration 3 to the core network based on the positioning information request message, which is specifically determined based on contents requested by the positioning information request message.

For instance, cell handover of the terminal may be that it is handed over from a cell corresponding to the gNB1 to a cell corresponding to the gNB2, and the AMF in the core network may determine that the terminal is handed over to the cell corresponding to the gNB2, so as to inform the LMF that the terminal is handed over to the cell corresponding to the gNB2.

The gNB2 may configure the position reference signal for the terminal and send the SRS configuration 2 to the terminal, so that the terminal sends an SRS to the base station according to resources indicated by the SRS configuration 2, and the gNB2 may measure the SRS sent by the terminal, so as to obtain a measurement result.

The core network may further send release indication information to the gNB3, so as to indicate the gNB3 to release resources corresponding to the SRS configuration 3.

The core network sends at least request information (for instance, it may be measurement request information in the NRPPa message) to the gNB2, so as to request to acquire the measurement result of the gNB2 on the sounding reference signal (SRS) sent by the terminal. The gNB2 measures the SRS sent by the terminal, and sends the obtained measurement result to the core network.

Accordingly, in a case that it is determined that the core network needs to position the terminal and cell handover of the terminal is needed, the gNB1 may inform the core network that the terminal is to be handed over to the cells gNB2 and gNB3, so that the core network may send the second acquisition request to the gNB2 and the gNB3, and the gNB2 and the gNB3 may configure uplink transmission SRS resources for the terminal. After the terminal is handed over to the cell corresponding to the gNB2, the core network may at least send request information to the gNB2 (also a neighbor base station of the gNB2), so that the gNB2 receives the SRS sent by the terminal and sends the measurement result obtained by measuring the SRS to the core network for the core network to determine the location of the terminal.

Corresponding to the aforementioned examples of the request sending method, the response information sending method and the position information acquisition method, the disclosure further provides examples of a request sending apparatus, a response information sending apparatus and a position information acquisition apparatus.

FIG. 16 is a schematic block diagram of a request sending apparatus [A1] 1600 illustrated according to an example of the disclosure. The apparatus shown in this example may be applied to a core network, the core network includes, but is not limited to, an LMF, an AMF and other functions, and the apparatus in one example may be specifically applied to the LMF.

The core network includes, but not limited to, a 5G core network and a 6G core network. The core network may communicate with a base station, for instance, an acquisition request for acquiring position information is sent to the base station, the position information includes, but not limited to, a measurement result of the base station on a sounding reference signal (SRS) sent by a terminal. The core network may determine a location of the terminal based on a plurality of (such as two or more than two) measurement results, and the terminal includes, but not limited to, a mobile phone, a tablet, a wearable device, an industrial sensor, an Internet of Things device and other electronic devices.

As shown in FIG. 16, the request sending apparatus 1600 may include a first request sending module 1601 and a second request sending module 1602.

The first request sending module 1601 is configured to send a first acquisition request for acquiring position information of a terminal to a first base station corresponding to a cell where the terminal is currently located.

The second request sending module 1602 is configured to, in response to determining, according to response information of the first acquisition request, a cell to which the terminal is to be handed over, send a second acquisition request for acquiring position information of the terminal to at least one base station corresponding to at least one target cell to which the terminal is to be handed over.

FIG. 17 is a schematic block diagram of another inquest sending apparatus [A2] 1700 illustrated according to an example of the disclosure. As shown in FIG. 17, the apparatus 1700 includes the first request sending module 1601 and the second request sending module 1602 and further includes a configuration acquiring module 1701.

The configuration acquiring module 1701 is configured to receive a first SRS configuration of the terminal determined by the first base station from the first base station, and receive a second SRS configuration of the terminal determined by the at least one base station from the at least one base station.

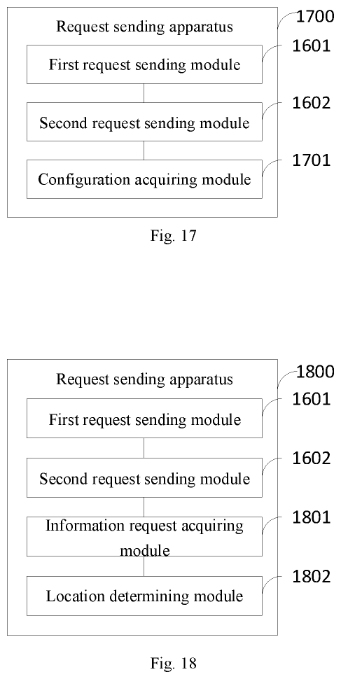

FIG. 18 is a schematic block diagram of another request sending apparatus [A3] 1800 illustrated according to an example of the disclosure. As shown in FIG. 18, the apparatus 1800 includes the first request sending module 1601 and the second request sending module 1602 and further includes an information request acquiring module 1801 and a location determining module 1802.

The information request acquiring module 1801 is configured to at least send, in response to determining that the terminal is handed over to a cell corresponding to a second base station among the at least one base station, request information to the second base station, where, the request information is used to request to acquire a measurement result of the second base station on a sounding reference signal (SRS) sent by the terminal.

The location determining module 1802 is configured to determine a location of the terminal according to the measurement result sent by at least the second base station.

In some embodiments, the request information carries an identifier of the terminal.

In some embodiments, the information request acquiring module is configured to send the request information to the second base station.

In some embodiments, the information request acquiring module is configured to send the request information to the second base station and at least one neighbor base station of the second base station.

In some embodiments, the request information carries a second SRS configuration of the terminal determined by the second base station.

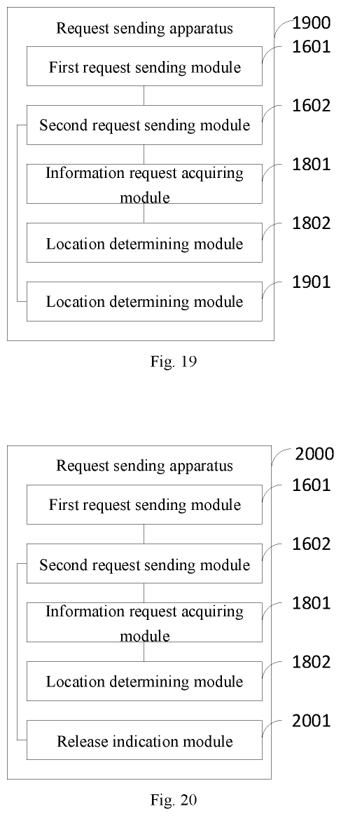

FIG. 19 is a schematic block diagram of yet another request sending apparatus [A4] 1900 illustrated according to an example of the disclosure. As shown in FIG. 19, the apparatus 1900 includes the first request sending module 1601, the second request sending module 1602, the information request acquiring module 1801, and the location determining module 1802 and further includes a first configuration sending module 1901.

The first configuration sending module 1901 is configured to send an SRS configuration of the terminal determined by the at least one base station to the first base station.

In some embodiments, the second acquisition request further includes a first SRS configuration of the terminal determined by the first base station.

FIG. 20 is a schematic block diagram of yet another request sending apparatus [A5] 2000 illustrated according to an example of the disclosure. As shown in FIG. 20, the apparatus 2000 includes the first request sending module 1601, the second request sending module 1602, the information request acquiring module 1801, and the location determining module 1802 and further includes a release indication module 2001.

The release indication module 2001 is configured to send release indication information to other base stations other than the second base station among the at least one base station, where, the release indication information is used to indicate the other base stations to release SRS resources configured for the terminal.

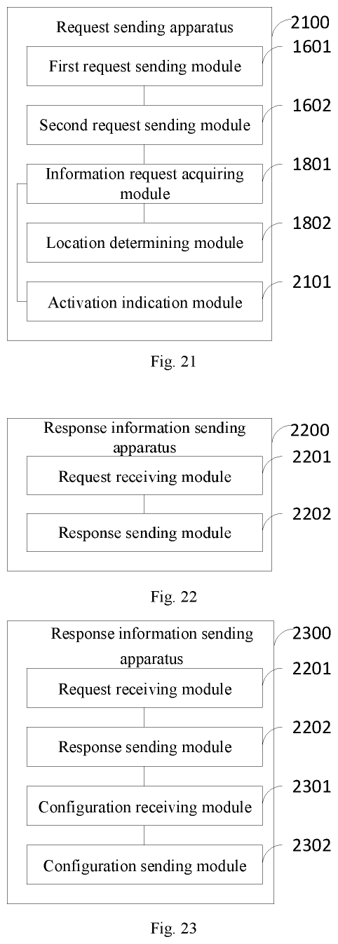

FIG. 21 is a schematic block diagram of yet another request sending apparatus [A6] 2100 illustrated according to an example of the disclosure. As shown in FIG. 21, the apparatus 2100 includes the first request sending module 1601, the second request sending module 1602, the information request acquiring module 1801, and the location determining module 1802 and further includes an activation indication module 2101.

The activation indication module 2101 is configured to send, in response to that the second SRS configuration of the terminal determined by the second base station is an aperiodic or semi-continuous sending SRS, activation indication information to the second base station, where, the activation indication information is used to indicate the second base station to activate the terminal to send the SRS.

FIG. 22 is a schematic block diagram of a response information sending apparatus [A7] 2200 illustrated according to an example of the disclosure. The apparatus 2200 shown in this example may be applied to a first base station, for instance, the first base station in the above request sending apparatus. The first base station includes, but not limited to, a 5G base station and a 6G base station. The first base station may communicate with the terminal and the core network, and the terminal includes, but not limited to, a mobile phone, a tablet, a wearable device, an industrial sensor, an Internet of Things device and other electronic devices.

As shown in FIG. 22, the response information sending apparatus 2200 may include a request receiving module 2201 and a response sending module 2202.

The request receiving module 2201 is configured to receive a first acquisition request for acquiring position information of a terminal sent by a core network.

The response sending module 2202 is configured to send, in response to determining a cell to which the terminal is to be handed over, response information of the first acquisition request to the core network, where, the response information is used to indicate at least one base station corresponding to at least one target cell to which the terminal is to be handed over to the core network.

FIG. 23 is a schematic block diagram of another response information sending apparatus [A8] 2300 illustrated according to an example of the disclosure. As shown in FIG. 23, the apparatus 2300 includes the request receiving module 2201 and the response sending module 2202 and further includes a configuration receiving module 2301 and a configuration sending module 2302.

The configuration receiving module 2301 is configured to receive a second SRS configuration of the terminal determined by a second base station sent by the core network, where, the second base station is a base station among the at least one base station to which the terminal is handed over.

The configuration sending module 2302 is configured to send the second SRS configuration to the terminal, and indicate the terminal to hand over to the second base station and then send an SRS based on the second SRS configuration.

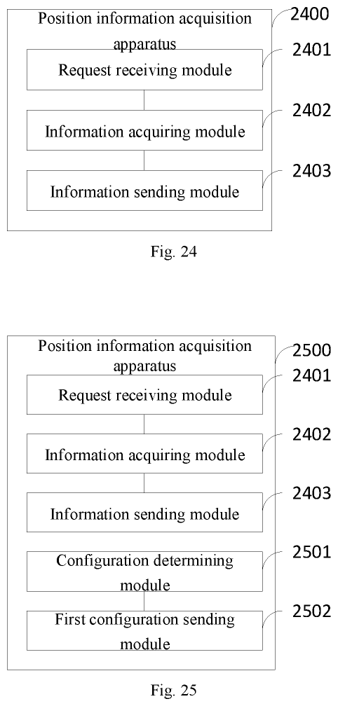

FIG. 24 is a schematic block diagram of a position information acquisition apparatus [A9] 2400 illustrated according to an example of the disclosure. The apparatus 2400 shown in this example may be applied to a second base station, for instance, the second base station in the above request sending apparatus. The second base station includes, but not limited to, a 5G base station and a 6G base station. The second base station may communicate with the terminal and the core network, and the terminal includes, but not limited to, a mobile phone, a tablet, a wearable device, an industrial sensor, an Internet of Things device and other electronic devices.

As shown in FIG. 24, the position information acquisition apparatus 2400 may include a request receiving module 2401, an information acquiring module 2402, and an information sending module 2403.

The request receiving module 2401 is configured to receive a second acquisition request for acquiring position information of a terminal sent by a core network.

The information acquiring module 2402 is configured to acquire, in response to that the terminal is handed over from a cell corresponding to a first base station to a cell corresponding to the second base station, a measurement result according to a request information sent by the core network, the measurement result is obtained by measuring an SRS sent by the terminal.

The information sending module 2403 is configured to send the measurement result to the core network.

FIG. 25 is a schematic block diagram of another position information acquisition apparatus [A10] 2500 illustrated according to an example of the disclosure. As shown in FIG. 25, the apparatus 2500 includes the request receiving module 2401, the information acquiring module 2402, and the information sending module 2403 and further includes a configuration determining module 2501 and a first configuration sending module 2502.

The configuration determining module 2501 is configured to determine a second SRS configuration of the terminal.

The first configuration sending module 2502 is configured to send the second SRS configuration to the terminal.

FIG. 26 is a schematic block diagram of another position information acquisition apparatus [A11] 2600 illustrated according to an example of the disclosure. As shown in FIG. 26, the apparatus 2600 includes the request receiving module 2401, the information acquiring module 2402, the information sending module 2403, the configuration determining module 2501, and the first configuration sending module 2502 and further includes a second configuration sending module 2601.

The second configuration sending module 2601 is configured to send the second SRS configuration to the core network.

In some embodiments, the apparatus 2600 further includes: a first configuration receiving module, configured to receive the second SRS configuration from the core network.

The information acquiring module 2402 is configured to receive an SRS sent by the terminal according to the second SRS configuration.

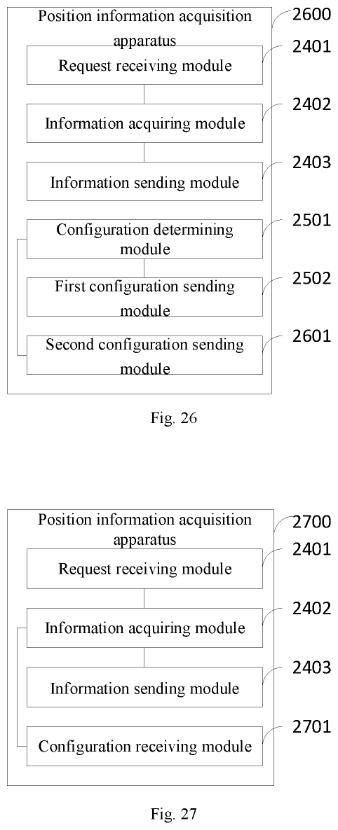

FIG. 27 is a schematic block diagram of yet another position information acquisition apparatus [A12] 2700 illustrated according to an example of the disclosure. As shown in FIG. 27, the apparatus 2700 includes the request receiving module 2401, the information acquiring module 2402, and the information sending module 2403 and further includes a second configuration receiving module 2701.

The second configuration receiving module 2701 is configured to receive a first SRS configuration of the terminal determined by the first base station from the core network.

The information acquiring module 2402 is configured to determine the second SRS configuration according to the first SRS configuration.

As for the apparatuses in the above examples, the specific manner in which each module performs operation has been described in detail in the examples of the related method, and detailed description will not be given here.

As for the apparatus examples, as it basically corresponds to the method examples, the related parts, please refer to the partial description of the method examples. The apparatus examples described above are merely illustrative. The modules described as separate components may or may not be physically separated, and components displayed as modules may or may not be physical modules, that is, they may be located in one place, or may be distributed to a plurality of network modules. Some or all of the modules may be selected according to actual needs to achieve the purpose of the solutions of the examples. Those of ordinary skill in the art can understand and implement it without creative labor.

An example of the disclosure further provides an electronic device, including: a processor; and a memory, configured to store processor executable instructions.

The processor is configured to implement the request sending method described in any above example, and/or the response information sending method described in any above example, and/or the position information acquisition method described in any above example.

An example of the disclosure further provides a computer readable storage medium, storing a computer program. The program, when executed by a processor, implements steps in the request sending method described in any above example, and/or the response information sending method described in any above example, and/or the position information acquisition method described in any above example.

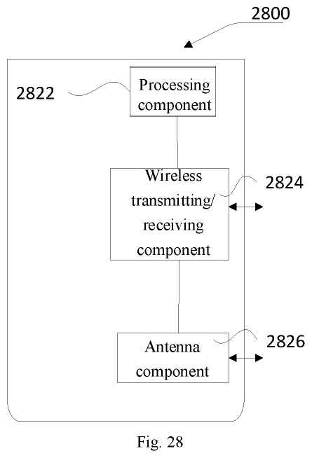

As shown in FIG. 28, which is a schematic block diagram of an apparatus 2800 for sending response information and/or acquiring above position information illustrated according to an example of the disclosure. The apparatus 2800 may be provided as a base station. Referring to FIG. 28, the apparatus 2800 includes a processing component 2822, a wireless transmitting/receiving component 2824, an antenna component 2826 and a signal processing part specific to a wireless interface, and the processing component 2822 may further include one or more processors. One processor in the processing component 2822 may be configured to implement the response information sending method described in any above example, and/or the acquisition method described in any above example.

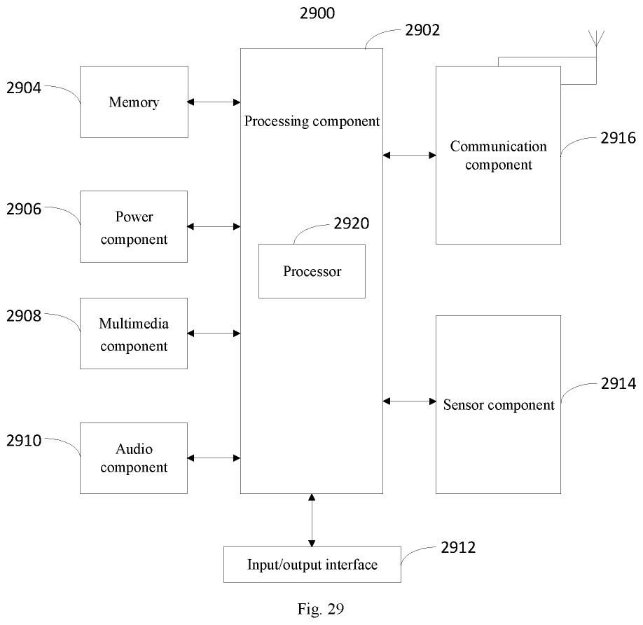

FIG. 29 is a schematic block diagram of a terminal 2900 illustrated according to an example of the disclosure. For instance, an apparatus 2900 may be a mobile phone, a computer, a digital broadcasting terminal, a messaging device, a game console, a tablet device, a medical device, a fitness device, a personal digital assistant, etc.

Referring to FIG. 29, the apparatus 2900 may include one or more of the following components: a processing component 2902, a memory 2904, a power component 2906, a multimedia component 2908, an audio component 2910, an input/output (I/O) interface 2912, a sensor component 2914, and a communication component 2916.

The processing component 2902 typically controls overall operation of the apparatus 2900, such as operations associated with display, telephone call, data communication, camera operations, and recording operations. The processing component 2902 may include one or more processors 2920 to execute instructions to complete all or part of the steps of the above method. In addition, the processing component 2902 may include one or more modules to facilitate interaction between the processing component 2902 and other components. For instance, the processing component 2902 may include a multimedia module to facilitate interaction between the multimedia component 2908 and the processing component 2902.

The memory 2904 is configured to store various types of data to support operation at the apparatus 2900. Instances of these data include instructions for any application or method operating on the apparatus 2900, contact data, phonebook data, messages, pictures, videos, etc. The memory 2904 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disk.

The power component 2906 provides power for various components of the apparatus 2900. The power component 2906 may include a power management system, one or more power sources and other components associated with generating, managing and distributing power for the apparatus 2900.

The multimedia component 2908 includes a screen providing an output interface between the apparatus 2900 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch panel. The touch sensor cannot merely sense the boundary of the touch or sliding operation, but also detect the duration and pressure related to the touch or sliding operation. In some examples, the multimedia component 2908 includes a front camera and/or a rear camera. When the apparatus 2900 is in an operation mode, such as a shooting mode or a video mode, the front camera and/or the rear camera may receive external multimedia data. Each front camera and rear camera may be a fixed optical lens system or have a focal length and optical zoom capability.

The audio component 2910 is configured to output and/or input audio signals. For instance, the audio component 2910 includes a microphone (MIC) configured to receive an external audio signal when the apparatus 2900 is in an operation mode, such as a call mode, a recording mode, and a speech recognition mode. The received audio signal may be further stored in the memory 2904 or transmitted via the communication component 2916. In some examples, the audio component 2910 further includes a speaker for outputting an audio signal.

The I/O interface 2912 provides an interface between the processing component 2902 and a peripheral interface module which may be a keyboard, a click wheel, buttons, etc. These buttons may include, but not limited to: a home button, volume buttons, a start button and a lock button.

The sensor component 2914 includes one or more sensors for providing state evaluation of various aspects of the apparatus 2900. For example, the sensor component 2914 may detect an on/off state of the apparatus 2900 and the relative position of the components, for example, the component is a display and a keypad of the apparatus 2900. The sensor component 2914 may also detect a change of the location of the apparatus 2900 or one component of the apparatus 2900, the presence or absence of contact of a user and the apparatus 2900, the azimuth or acceleration/deceleration of the apparatus 2900, and a temperature change of the apparatus 2900. The sensor component 2914 may include a proximity sensor configured to detect the presence of nearby objects without any physical contact. The sensor component 2914 may further include an optical sensor, such as a CMOS or CCD image sensor, for use in imaging applications. In some examples, the sensor component 2914 may further include an acceleration sensor, a gyroscope sensor, a magnetic sensor, a pressure sensor, or a temperature sensor.

The communication component 2916 is configured to facilitate wired or wireless communication between the apparatus 2900 and other devices. The apparatus 2900 may access a wireless network based on a communication standard, such as WiFi, 2G or 3G, 4G LTE, 5G NR or their combination. In an example, the communication component 2916 receives a broadcast signal or broadcast-related information from an external broadcast management system via a broadcast channel. In an example, the communication component 2916 further includes a near field communication (NFC) module to facilitate short-range communication. For instance, the NFC module may be implemented based on a radio frequency identification (RFID) technology, an infrared data association (IrDA) technology, an ultra wideband (UWB) technology, a Bluetooth (BT) technology and other technologies.

In an example, the apparatus 2900 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the above methods.

In an example, a non-transitory computer-readable storage medium including instructions, such as the memory 2904 including instructions, which can be executed by the processor 2920 of the apparatus 2900 to complete the above method, is also provided. For instance, the non-transitory computer-readable storage medium may be an ROM, a random access memory (RAM), a CD-ROM, a magnetic tape, a floppy disk, an optical data storage device, etc.

Other implementations of the disclosure will be apparent to those skilled in the art from consideration of the specification and practice of the disclosure here. The disclosure is intended to cover any variations, uses, or adaptive changes of the disclosure, these variations, uses, or adaptive changes conform to a general principle of the disclosure and include common general knowledge or conventional technical means which are not disclosed here in the technical field. It is intended that the specification and examples be considered as examples merely, with a true scope and spirit of the disclosure being indicated by the following claims.

It will be appreciated that the disclosure is not limited to the exact construction that has been described above and illustrated in the accompanying drawings, and that various modifications and changes may be made without departing from its scope. The scope of the disclosure merely is limited by the appended claims.

It needs to be noted that in this article, relational terms such as first and second are merely used to distinguish one entity or operation from another entity or operation, and do not necessarily require or imply any such actual relationship or order between these entities or operation. The terms “include”, “comprise” or its any other variants are intended to cover non-exclusive inclusion, so that a process, method, article or device including a series of elements not merely includes those elements, but also includes other elements not clearly listed, or also includes elements inherent to this process, method, article or device. Without further restrictions, the elements defined by the statement “including one . . . ” do not exclude that there are other identical elements in the process, method, article or device including the elements.

The methods and apparatuses provided by the examples of the disclosure are described in detail above. Specific instances are used in this article to describe the principles and implementations of the disclosure. The description of the above examples is merely used to help understand the methods and core ideas of the disclosure. At the same time, for those of ordinary skill in the art, according to the idea of the disclosure, there will be changes in the specific implementations and scope of application. To sum up, the content of the specification should not be interpreted as a restriction on the disclosure.

1. A request sending method, applicable to a core network, and comprising:
sending a first acquisition request for acquiring position information of a terminal to a first base station corresponding to a cell where the terminal is currently located; and
in response to determining, according to response information of the first acquisition request, a cell to which the terminal is to be handed over, sending a second acquisition request for acquiring position information of the terminal to at least one base station corresponding to at least one target cell to which the terminal is to be handed over.

2. The method according to claim 1, further comprising:
at least sending, in response to determining that the terminal has been handed over to a cell corresponding to a second base station among the at least one base station, request information to the second base station, wherein, the request information is used to request to acquire a measurement result of the second base station on a sounding reference signal (SRS) sent by the terminal; and
determining a location of the terminal according to the measurement result sent by at least the second base station.

3. The method according to claim 2, wherein the request information carries at least one of an identifier of the terminal or a second SRS configuration of the terminal determined by the second base station.

4. The method according to claim 2, wherein at least sending the request information to the second base station comprises:
sending the request information to the second base station.

5. The method according to claim 2, wherein at least sending the request information to the second base station comprises:
sending the request information to the second base station and at least one neighbor base station of the second base station.

6. (canceled)

7. The method according to claim 2, further comprising:
sending release indication information to other base stations other than the second base station among the at least one base station, wherein the release indication information is used to indicate the other base stations to release SRS resources configured for the terminal.

8. The method according to claim 3, further comprising:
sending, in response to the second SRS configuration of the terminal determined by the second base station to be an aperiodic or semi-continuous SRS, activation indication information to the second base station, wherein the activation indication information is used to indicate the second base station to activate the terminal to send the SRS.

9. The method according to claim 1, further comprising:
sending an SRS configuration of the terminal determined by the at least one base station to the first base station.

10. The method according to claim 1,
wherein the second acquisition request further comprises a first SRS configuration of the terminal determined by the first base station.

11. The method according to claim 1, further comprising:
receiving a first SRS configuration of the terminal determined by the first base station from the first base station; and
receiving a second SRS configuration of the terminal determined by the at least one base station from the at least one base station.

12. A response information sending method, applicable to a first base station, and comprising:
receiving a first acquisition request for acquiring position information of a terminal sent by a core network; and
sending, in response to determining a cell to which the terminal is to be handed over, response information of the first acquisition request to the core network, wherein, the response information is used to indicate at least one base station corresponding to at least one target cell to which the terminal is to be handed over to the core network.

13. The method according to claim 12, further comprising:
receiving a second SRS configuration of the terminal determined by a second base station sent by the core network, wherein
the second base station is a base station among the at least one base station to which the terminal is handed over; and
sending the second SRS configuration to the terminal, and indicating the terminal to hand over to the second base station and then send an SRS based on the second SRS configuration.

14. A position information acquisition method, applicable to a second base station, and comprising:
receiving a second acquisition request for acquiring position information of a terminal sent by a core network;
acquiring, in response to that the terminal is handed over from a cell corresponding to a first base station to a cell corresponding to the second base station, a measurement result according to a request information sent by the core network, the measurement result is obtained by measuring an SRS sent by the terminal; and
sending the measurement result to the core network.

15. The method according to claim 14, further comprising:
determining a second SRS configuration of the terminal; and
sending the second SRS configuration to the terminal.

16. The method according to claim 15, further comprising:
sending the second SRS configuration to the core network.

17. The method according to claim 16, further comprising:
receiving the second SRS configuration from the core network; and
receiving an SRS sent by the terminal according to the second SRS configuration.

18. The method according to claim 15, further comprising:
receiving a first SRS configuration of the terminal determined by the first base station from the core network; and
determining the second SRS configuration according to the first SRS configuration.

19-21. (canceled)

22. An electronic device, comprising:
a processor; and
a memory, configured to store processor executable instructions; wherein
the processor is configured to implement the request sending method according to claim 1.

23. (canceled)

24. An electronic device, comprising:
a processor; and
a memory, configured to store processor executable instructions; wherein
the processor is configured to implement the response information sending method according to claim 12.

25. An electronic device, comprising:
a processor; and
a memory, configured to store processor executable instructions; wherein
the processor is configured to implement the position information acquisition method according to claim 14.
